(19) United States
(12) Patent Application Publication
(10) Pub. No.: US 2013/0254300 A1
(43) Pub. Date: Sep. 26, 2013

(54) Computer-based Methods and Systems for Verifying User Affiliations for Private or White Label Services

(71) Applicants: Adam Berk, New York, NY (US); John Boyd, Ridgefield, CT (US)

(72) Inventors: Adam Berk, New York, NY (US); John Boyd, Ridgefield, CT (US)

(21) Appl. No.: 13/426,599

(22) Filed: Mar. 22, 2012

(51) Int. Cl. G06F 15/16

(52) U.S. Cl. 709/206

(57) ABSTRACT

Systems and methods that allow one or more individuals to verify or authenticate their affiliation or status and thereby join or have access to multiple private or white label deals, offerings or services.

### TECHNICAL FIELD

The present invention relates to online or mobile computing. More particularly, the present invention relates to improved systems and methods that allow one or more individuals to verify or authenticate their affiliation or status and thereby join or have access to multiple private or white label deals, offerings or services.

### BACKGROUND

Several publications are referenced in this application. The cited references describe the state of the art to which this invention pertains and are hereby incorporated by reference.

There are a variety of on-line networking services that allow users to learn about other users and possibly network with such other users, such as Facebook.com, MySpace.com, Friendster.com, Orkut.com, and Plaxo.com. Users connected to a network (e.g. internet, mobile, instant messaging, etc.) often use fictitious screen names as unique handles (“usernames” or “screen names”) to identify themselves to other users. An individual user may have multiple screen names. Users communicate online with these fictitious identities either in online text messages, referred to as instant messaging (IM), or in voice, with special voice over IP software applications like Skype, without knowing the true identities of the other parties. This protects the identity of the users as long as users do not give out any private information, such as full names, telephone numbers, email address or other contact information. Anonymity is a significant driver for Internet use. As a result, social networking sites are resistant to any solution that reveals the identity of its users or in any way jeopardizes the anonymity. However, without some form of verification of a user's profile information or published or shared personal characteristics, some users are enabled to falsely portray their own personal characteristics, for example, occupation, education, group membership, affiliations, etc.

US Patent Publication No. 20090265639 to Shuster, hereby incorporated by reference (particularly the systems and methods described in paragraphs 0008-0048), describes systems and methods for verifying user personal characteristics. The method includes: receiving from a first user on a social network personal information about the first user; requesting veracity feedback of one or more items of personal information of the first user from a plurality of users on the social network; assigning a confidence score (also called a veracity score) to each item of personal information based on respective veracity feedback provided by one or more of the plurality of users; and publishing, on the social network, the confidence score of the first user's personal information to one or more users of the social network.

### SUMMARY OF THE INVENTION

One aspect of the invention relates to improved systems and methods that allow one or more individuals to verify or authenticate their identity, background information, affiliations, alumni status or other information and thereby gain access or be allowed to sign up or register with or use one or more private or white label services, offerings or deals.

Private label services include those allowing users to meet or otherwise network or connect or transact or exchange information, tangibles or intangibles, share or swap accommodations, rides, etc., with other individuals. Examples include Guestvessel.com's, Neighborrow.com's and MeetingWave.com's private label versions for fellow alumni, association members, conference/trade show attendees or other large groups of individuals with common interests or affiliations. The improvements of the present invention can be applied to or used with the systems and methods set forth in U.S. Pat. Nos. 6,963,900 and 7,483,946, U.S. application Ser. No. 12/286,565, International Application PCT/US2007/076955, filed Aug. 28, 2007 (now PCT Patent Publication WO 2008/030729) and those set forth in U.S. application Ser. No. 12/396,456, filed March, 2008, and U.S. Provisional Application No. 61/328,813, filed Apr. 28, 2010, commonly assigned and hereby incorporated by reference, specifically, the systems and methods that allow one or more individuals (“inviting individual” or “inviter”) to verify their information or meet or otherwise network or connect or exchange information, tangibles or intangibles with other individuals by creating and posting an electronic invitation including proposed meeting information (e.g., a specified time or time range, specific location or general location (e.g., neighborhood, zip code), purpose, etc.) or a request for an invitation or post a “Let's Meet” or “Available” indication at a website or other electronic location accessible by other users via the Internet or other computer-based network and allowing other individuals to review such invitations or requests or indication and, if confirmed, result in a meeting.

One embodiment of the invention relates to methods and systems for verifying, authenticating, and/or rating the identity or profile characteristics of users of online social networks and other websites and applications using the verification of an approved email domain or other verification or authenticating functionality to allow the user to register at one or more, preferably two or more private or white label websites, apps, deals or offerings. For example, a user verifies an email address with a @alumni.mit.edu email domain (e.g., john.smith@alumni.mit.edu) to gain access to one or more private label services closed to alumni of MIT, preferably two or more services.

Another embodiment relates to systems and methods of verifying users using a click thru verification link in an email, app or third party site. For example, a user clicking through the verification link placed on a private page within the alumni website would be allowed or have access to one or more, preferably two or more, private or white label services, deals or other offerings for alumni of that university or college.

Other aspects as well as embodiments, features and advantages of the present invention will become apparent from a study of the present specification, including the drawings, claims and specific examples.

### BRIEF DESCRIPTION OF THE DRAWINGS

FIG. 1 is a block diagram that depicts a system architecture in accordance with an embodiment of the present invention.

FIG. 2 is a process flow diagram for rule-based verification in accordance with an embodiment of the present invention.

### DESCRIPTION OF THE INVENTION

The methods of the invention may be performed using one or more computers in communication with a plurality of clients/mobile device apparatuses and running application or other software to perform the recited actions. The computing environment should not be interpreted as having any dependency or requirement relating to any one or combination of components illustrated in the exemplary operating environment.

The invention may be operational with numerous other general purpose or special purpose computing system environments or configurations, preferably running or including software code enabling the inventive methods and functionality. Examples of well known computing systems, environments, and/or configurations that may be suitable for use with the invention include, but are not limited to, personal computers, server computers, hand-held, smartphone, mobile, tablet, desktop or laptop devices, multiprocessor systems, microprocessor-based systems, set top boxes, programmable consumer electronics, network PCs, minicomputers, mainframe computers, distributed computing environments that include any of the above systems or devices, and the like.

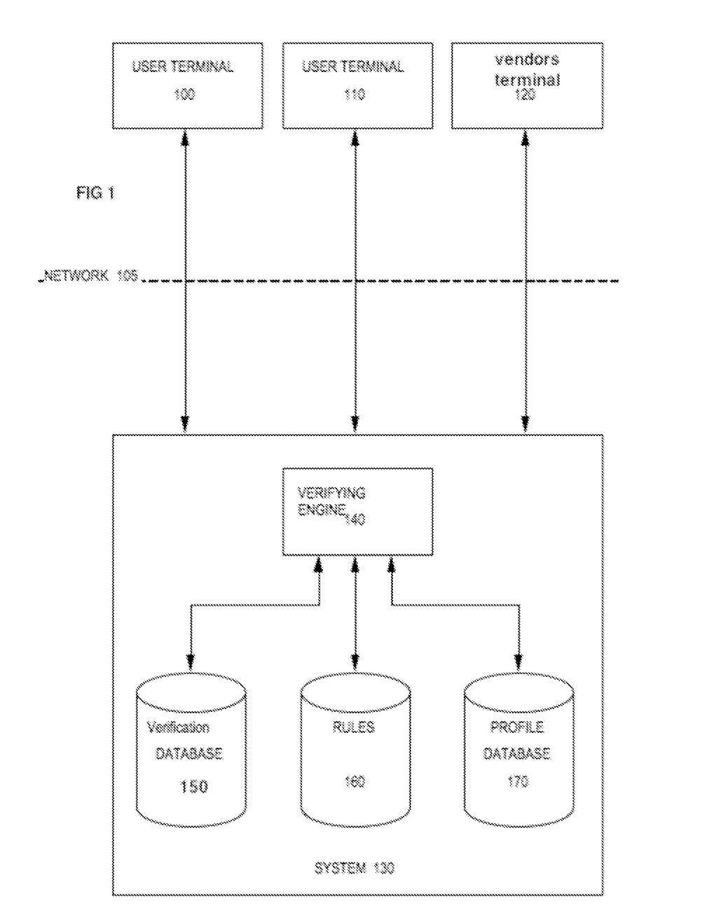

The invention may be described in the general context of computer-executable instructions, such as program modules, being executed by a computer. Generally, program modules include routines, programs, objects, components, data structures, etc., that perform particular tasks or implement particular abstract data types or functionality. The invention may also be practiced in distributed computing environments where tasks are performed by remote processing devices that are linked through a communications network. In a distributed computing environment, program modules may be located in both local and remote computer storage media including memory storage devices. Suitable computer-based systems are described in U.S. Pat. No. 7,571,319 to Gillum et al., hereby incorporated by reference (specifically the description of the systems relating to FIGS. 1 and 7).

FIG. 1 depicts a system architecture in accordance with an embodiment of the present invention. The architecture may include terminals operated by users (100,110) and/or vendors (e.g., private label services providers) (120) in communication with the system (130) of the present invention, which may include a verification engine (140) coupled with several databases that verification database (150), processing rules (160) and user profiles (170).

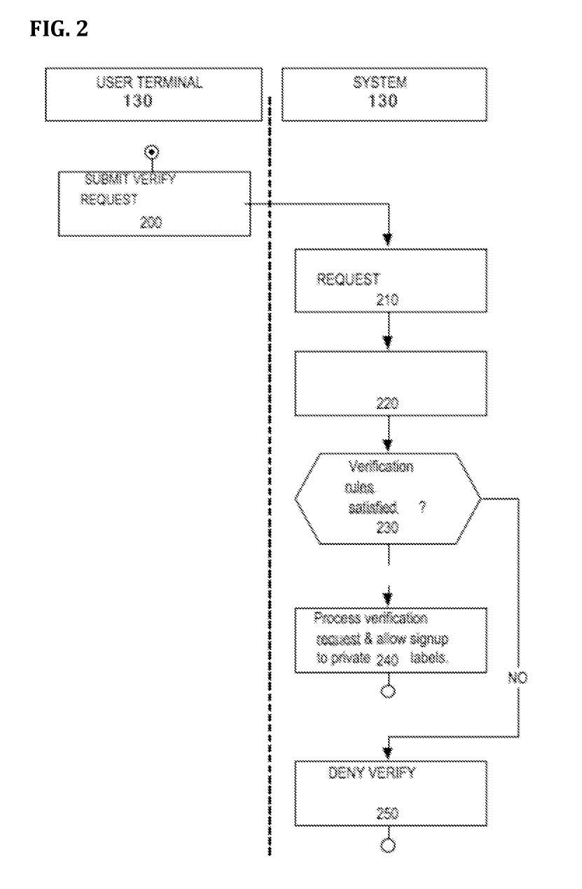

FIG. 2 depict the application of rules by the verification engine (140) of the system (130) in connection with requests for verification and entry into or access to one or more, preferably two or more, private label services, offerings or deals.

In FIG. 2, a terminal (100) operated by a user submits (step 200) to the system (130) a request over a network (105) for verification. The system (130) receives (step 210) the request and determines (steps 220, 230) whether one or more rules associated with verification, such as those stored in a rules database (160), apply to the verification request. The system (130) then processes (step 240) the verification request if all determined applicable (e.g., required or necessary rules) rules are satisfied, and denies (step 250) the verification request if any determined applicable rule is not satisfied. For example, the request may be denied if an email address is submitted without the approved email domain or if the submitted email address is never verified by the user clicking through the verification email sent to the email address.

The rules described in FIG. 2 may derive from preferences stored in profiles (170) associated with users and/or vendors affiliated with the system (130), security criteria, and other situations as described below for example.

According to one embodiment of the invention, systems and methods are provided that authenticates or verifies the identity, status (e.g., alumni, employment, registrations or membership) or background information of a user and stores that information in a database or other electronic format in a manner that allows the user to have access to one or more, preferably two or more private or white label or closed versions of services, offerings or deals.

According to another embodiment of the invention, users are requested to provide a valid email address to register on the verification website or application and a verification email is sent to the user at the email address that is provided. The user is required to click through or otherwise confirm that the verification email was received (e.g., retrieving a code and inputting on the site or clicking through a link on the email). After the user has verified the email, the user can sign up, register, receive or otherwise access one or more, preferably two or more, private label, while label or closed versions of services (e.g., private label SaaS websites), deals or other offerings.

Preferably, the verified or authenticated users lands on a webpage or receives an email that allows the users to signup, register or otherwise have access to one or more, preferably two or more, even more preferably three or more, private or white label services, deals or other offerings.

The invention provides advantages to users since they can be provided with access to multiple private or white label or otherwise closed services, deals or offerings with a single verification step. That is, rather than going through the verification step for each private label, they can verify once and gain access to multiple services.

The invention also provides advantages to alumni relations office, associations, conferences, trade shows and other entities since a single verification link can be used on a website or email to allow access to multiple private label offerings. Moreover, if an alternate version of verification is used (rather than email address or verification link) such as unicodes or other verification information, that information need only be provided to the verification service provider rather than each private label service. For example, a university provides unicodes/passwords to the verification service and users providing matching unicodes/passwords can than gain access to multiple private label services. As another example, a conference or trade show organizer can provide registration numbers to the verification service and users providing matching registration numbers verifying they are registered attendees can gain access to multiple private label services without each private label services being provided with registration numbers.

And finally, there are advantages provided to private label service providers since they can jointly market, sell and otherwise promote their private label services, deals or offerings using a single verification platform or methodology. For example, one embodiment of the invention relates to a website whereby users can submit an email to become verified and upon verification the user arrives back at the website with access to multiple private label services, deals or other offerings.

According to one preferred embodiment, the verification process includes the user providing a valid email address, a verification email being sent to that email address and the user can open and click thru or otherwise confirm the verification email was received. Thereafter, the user has access to or can signup, register or otherwise use the two or more private or white label or closed services, deals or other offerings.

Other verification methods may include inputting a specific code or registration number or clicking through a link from a specified website (e.g., a password protected alumni or conference or association website). For example, if a user is a registered attendee to a conference, the user may be provided with a registration number that can be used to verify the user is registered to attend the conference or trade show and after submitting the registration for verification the user is provided access to one or more, preferably two or more, private or white label services.

According to one embodiment, upon arriving on the web site or application, the user is provided with an option to sign up for the services. Preferably, if the user decides to sign up for the service, a form is presented to the user requesting additional information to be used for the service. The information may include, but is not limited to: (a) name, (b) username or screen name, (c) email address, and (d) PIN or password for accessing the service.

Preferably, the member can create or update his or her profile data at any time through the web or mobile interface. Preferably, the user can return for signing up, registering or accessing additional or new services, deals, or other offerings associated with the verification.

According to one preferred embodiment, the method and system allows users to create a profile and opt to use the profile with one or more of the private label or white label or closed versions of the services, deals or offerings.

Preferably, the member receives regular followup verification requests for verified emails to confirm still verified. For example, “John Smith” may have formerly worked at IBM and had a verifiable email address john.smith@ibm.com. However, if the user leaves IBM than the user would no longer be able to verify the email address. Accordingly, preferably a regular verification email (e.g., weekly, monthly, quarterly, yearly) is sent to each verified email domain and if the member fails to verify the email within a specified period of time, the user will no longer have access to the private label services.

According to one preferred embodiment, the method or system recognizes email domains that are likely to change for the user compared to more permanent email domains. For example, a verified email domain associated with a company may require re-verification periodically, while an email domain indicating alumni status would not require re-verification since that attribute or characteristic is permanent and not subject to change.

Another embodiment relates to a computer-based method of verifying a user comprising:

(a) verifying an email address provided by said user; and
(b) allowing said user to register or access two or more private label, white label or closed services, deals or offers after said verifying.

Preferably, the email address includes an email domain for a company, association, college or university. According to one preferred embodiment, the verifying: (i) confirms the user is an alumnus from a college, university or school, (ii) confirms the user is a registered attendee for a conference, trade show or expo, (iii) confirms the user is a member of an association, (iv) confirms the user is an employee of a company, or (v) confirms the user is a guest of a hotel, resort, cruise or event.

Preferably, the user must be verified before registering or accessing said two or more private label, white label or closed services, deals or offers.

Another embodiment relates to a computer-based method of verifying a user comprising:

(a) verifying said user; and

(b) allowing said user to register or access two or more private label, white label or closed services, deals or offers after said verifying.

Preferably, the verifying is achieved by verifying an email address provided by the user and/or by the user verifying via a click through verification link. Preferably, the verification link is placed on a private page on a third party website or email. Preferably, the step of verifying registers said user to use or access said private label, white label or closed services, deals or offers. Preferably, the verifying allows said user to register use or access said two or more private label, white label or closed services, deals or offers.

Preferably, the email address includes an approved email domain for a company, association, college or university.

Yet another embodiment relates to a method for registering a user for two or more private label online services, offerings or deals, comprising:
receiving by a server a request from a user over a network to register;
determining whether one or more rules associated with verification apply to the request from the user to register;
processing the request if all rules determined to be applicable are satisfied; and
denying the request if one or more rules determined to be applicable are not satisfied;
wherein said method further comprises:

(a) verifying an email address provided by said user; and

(b) allowing the user to register for said two or more private label online services, offerings or deals.

A still further embodiment relates to a computer based system capable of verifying and registering users comprising a processor coupled to a memory, the memory having computer readable code, which when executed by the processor causes the computer system to perform the methods described herein.

A still further embodiment of the invention relates to computer program products comprising software instructions for carrying out the steps in one or more of the above methods. Preferably, the products include: a user interface for interacting with a user; a network connection; a persistent storage such as a database; a memory for storing software instructions; and a processor operatively connected to the memory, the processor for executing the software instructions; wherein the software instructions enable the processor to carry out the method steps described above.

The method can also be implemented as machine executable instructions executed by a programmable information processing system or as hard coded logic in a specialized computing apparatus such as an application-specific integrated circuit (ASIC). Suitable related systems suitable for implementing the methods and systems of the invention are described in U.S. Pat. No. 7,509,230 to Fernandez et. al. (description of FIGS. 1 and 2 in the specification); US Patent Application Publication No. 20080120166 to Fernandez et al. (description of FIGS. 1 and 2 in the specification); and US Patent Application No 20080126344 to Hoffman et al., which describes methods and systems of rating the reputation of email address, such methods and systems hereby incorporated by reference (specifically paragraphs 0036-0040).

Preferably, the “private label” or “white label” or closed websites, applications, deals or other offerings are closed to users who have been verified by the methods according to the invention (unless allowed to be waived in or other access provided by administration functionality). For example, one private label may include online or mobile tools for arranging networking meetings among users with common affiliations or associations (e.g., fellow alumni, conference attendees, trade show attendees, hotel guests, etc). Preferably, the private label version allows individuals with common interests or affiliations to arrange networking meetings with each other in a closed format. According to another embodiment, the version is semi-closed in that all invites for networking meetings are created by individuals with common associations or affiliations (e.g., members of a law firm, representatives of a company, etc.), which others outside the group (e.g., the public) can accept the invites. Other examples of private label websites include those allowing users to share items (e.g., neighborrow.com), share or swap accommodations (e.g., guestvessel.com), carpool/share rides, etc.

Preferably, the methods and systems of the invention allow users to access two or more, three or more, five or more or ten or more, private label, white label or closed services, deals, or other offerings.

Preferably, the system allows additional private labels to be added to individual verification process associated with a private label series (e.g, for alumni from a specific college or university).

According to one embodiment, a private label version or series is generated at the request of an individual or entity by providing one or more verification or authentication methodologies (e.g., specified email domains for email address verification, registration numbers or codes, click-thru links, etc). Preferably, one or more email domains may be associated with the private label series allowing users with different but related email domains (e.g., alumni.upenn.edu and wharton.upenn.edu) to use the private label version upon email verification.

According to another embodiment, a private label version or series is generated at the request of an individual or entity by providing one or more of the following: (a) logo or design; (c) copy or other customization; (c) payment of a fee; (d) verification or authentication methodologies (e.g., specified email domains for email address verification, registration numbers or codes, click-thru links, etc). Preferably, one or more email domains may be associated with the private label allowing users to use the private label version upon email verification.

According to one preferred embodiment, the systems and methods allow a private label series generator to choose one or more of the verification methodologies: (a) specified email domain verification; (b) registration code or number verification; (c) directional link verification (e.g., link to private label provided behind a wall); and(c) user name or other identification verification.

Preferably, users can be verified for or “belong” to one or more private labels series. For example, an individual user may be verified and belong to different private labels for the members undergraduate alumni association, graduate school (e.g., law school or business school), and for a trade show or conference the member is attending. Preferably, the members can enter and exit into and out of such private label version. Preferably, members can cancel “memberships” to said private label versions if no longer applicable or no longer of interest. Preferably, the member gain access to each new private label upon establishing verified to enter and use (e.g., by providing an authorized email address, registration code, etc.).

According to another embodiment, the private label is for a conference or trade show and user membership to such private label is terminated after the end of the event. Preferably, members are able to arrange meetings with other members after the conference/trade show is over.

According to another embodiment, a private label version is created at the request of a private label requester. Preferably, the private label requester can provide the verification procedure for verifying a user to use the private label. For example, the private label requester can request that user enter a specified code or sign up with an approved email domain. For example, a private label requester that is an alumni association requesting a private label for alumni may request users provide a valid, verified email address that includes an alumni email address (e.g., alumni.columbia.edu). Or a conference or trade show organizer may request that users provide a registration number or other code. Another example would include a hotel private label which would require a guest number or other verification the user is a guest of the hotel before being allow to register and arrange meetings with other hotel guests at the hotel's restaurant, bar, golf course or other hotel venue.

Another embodiment of the invention relates to a computer-based method for verifying a user for one or more private or while label or closed version websites, applications, deals or other offerings comprising:

receiving by a server a request from a first user over a network to verify including an email address;
determining whether one or more rules associated with verification apply to the request from the first user;
processing the request if all rules determined to be applicable are satisfied;
and denying the request if one or more rules determined to be applicable are not satisfied;
wherein said registration requires the verification of a valid email address having an specified email domain.

Preferably, said first user can perform additional registrations for the two or more private label websites, apps, deals or other offerings using additional email addresses with different approved email domains.

The methods of the invention can also be implemented as machine executable instructions executed by a programmable information processing system or as hard coded logic in a specialized computing apparatus such as an application-specific integrated circuit (ASIC). Suitable related systems suitable for implementing the methods and systems of the invention are described in U.S. Pat. No. 7,532,900 to Wilson et. al. (description of “Representative System” and “Representative Message Flows” including FIGS. 1 and 2 and the flow diagrams of FIGS. 3-12 and associated description). The systems' and methods' data may be stored in one or more data stores. The data stores can be of many different types of storage devices and programming constructs, such as RAM, ROM, Flash memory, programming data structures, programming variables, etc. It is noted that data structures describe formats for use in organizing and storing data in databases, programs, memory, or other computer-readable media for use by a computer program.

The systems and methods of the invention may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. Suitable systems are described in U.S. Pat. No. 7,603,556 to Brown et al. (specifically, the descriptions of FIGS. 1, 2 and 5) and U.S. Pat. No. 7,673,327 to Polis et al (specifically the description of FIG. 1), each hereby incorporated by reference.

While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention. For example, software modules that implement the present invention such as the meeting engine (140) may comprise several discrete modules that together still provide the same functionality, data specified in the illustrated databases (150, 160, 170) may be spread over several databases and/or systems (e.g., a server may be two or more servers acting together) and the flow diagram of FIG. 2 may encompass combined steps or several intermediate steps that do not detract from the higher level functionality described therein. As used herein and in the appended claims, a “server” should be understood to refer to one server or more than one server.

1. A computer-based method of verifying a user comprising:
(a) verifying an email address provided by said user; and
(b) allowing said user to register or access two or more private label, white label or closed services, deals or offers after said verifying.

2. The method of claim 1, wherein said email address includes an email domain for a company, association, college or university.

3. The method of claim 1, wherein said verifying confirms the user is an alumnus from a college, university or school.

4. The method of claim 1, wherein said verifying confirms the user is a registered attendee for a conference, trade show or expo.

5. The method of claim 1, wherein said verifying confirms the user is a member of an association.

6. The method of claim 1, wherein said verifying confirms the user is an employee of a company.

7. The method of claim 1, wherein said user must be verified before registering or accessing said two or more private label, white label or closed services, deals or offers.

8. A computer-based method of verifying a user comprising:
(a) verifying said user; and
(b) allowing said user to register or access two or more private label, white label or closed services, deals or offers after said verifying.

9. The method of claim 8, wherein said verifying is achieved by verifying an email address provided by the user.

10. The method of claim 8, wherein said verifying is achieved by the user verifying via a click through verification link.

11. The method of claim 10, wherein said verification link is placed on a private page on a third party website.

12. The method of claim 8, wherein said verifying registers said user to use or access said private label, white label or closed services, deals or offers.

13. The method of claim 8, wherein said verifying allows said user to register use or access said two or more private label, white label or closed services, deals or offers.

14. The method of claim 9, wherein said email address includes an approved email domain for a company, association, college or university.

15. A method for registering a user for two or more private label online services, offerings or deals, comprising:
receiving by a server a request from a user over a network to register;
determining whether one or more rules associated with verification apply to the request from the user to register;
processing the request if all rules determined to be applicable are satisfied; and
denying the request if one or more rules determined to be applicable are not satisfied;
wherein said method further comprises:
(a) verifying an email address provided by said user; and
(b) allowing the user to register for said two or more private label online services, offerings or deals.

16. A computer based system capable of verifying users comprising a processor coupled to a memory, the memory having computer readable code, which when executed by the processor causes the computer system to perform the method of claim 1.
